(19) United States
(12) Patent Application Publication
(10) Pub. No.: US 2026/0209116 A1
(43) Pub. Date: Jul. 23, 2026

(54) METHOD FOR PRODUCING A RECONSTITUTED MINERAL AGGREGATE, RECONSTITUTED MINERAL AGGREGATE AND USES THEREOF

(71) Applicant: NEOLITHE, BEAULIEU-SUR-LAYON (FR)

(72) Inventors: Louis JARDIN, Angers (FR); François-Xavier HERMELLIN, Angers (FR); William Francis CRUAUD, Val-du-Layon (FR)

(21) Appl. No.: 19/141,440

(22) PCT Filed: Dec. 20, 2023
(86) PCT No.: PCT/IB2023/063043

§ 371 Date: Jun. 20, 2025

(30) Foreign Application Priority Data
Dec. 21, 2022 (FR) FR2214184

(51) Int. Cl. C04B 18/02; C04B 18/12; C04B 18/16

(52) U.S. Cl. CPC C04B 18/021; C04B 18/12; C04B 18/16

(57) ABSTRACT

The invention relates to a process for manufacturing a reconstituted mineral aggregate, characterised in that at least one particulate mineral starting material is mixed with water and at least one mineral binder which can be hardened in the presence of water and/or at least one system capable of forming a hardened mineral binder in an aqueous medium, to obtain a material in the form of a wet powder which is compressed by extrusion or pressing in order to intimately mix the binder and/or system capable of forming the binder/particulate starting material/water and to increase the intrinsic density and reduce the intrinsic porosity of the material, and to obtain, as a result of the hardening the binder or binders, a hardened, solid mass which is in the form of the granulate of the size and/or shape desired, or is transformed into the granulate of the size and/or shape desired by cutting or crushing, immediately after compression or in a subsequent stage.

The present invention relates to a process for manufacturing a reconstituted mineral aggregate, to a reconstituted mineral aggregate obtainable by this process, and to applications for these aggregates.

As part of the current drive to save resources and limit waste, circular economy solutions have been widely adopted in the building and public works sector, particularly to save on new aggregates. Crushed concrete, incinerator bottom ash and crystallised slag are currently being used as aggregates to replace natural aggregates extracted from quarries.

However, while granular reduction techniques, such as crushing and screening, exist and can be used to obtain usable aggregate from hard blocks, there is no proven method for transforming mineral lumps and fines into usable-sized aggregate.

It is the objective of the present invention to satisfy this need, the process proposed for this purpose consisting in selecting at least one mineral granular base material having a large specific surface area or in grinding at least one mineral granular base material so that it achieves such a granulometry by increasing its specific surface area, in adding at least one binder and water, in pressurising the assembly and in carrying out a shaping operation to form the desired granulate.

The first object of the present invention is therefore a process for manufacturing a reconstituted mineral aggregate, characterized in that at least one particulate mineral starting material for aggregate is mixed with water and at least one mineral binder which can be hardened in the presence of water and/or at least one system capable of forming a hardened mineral binder in an aqueous medium, in order to obtain a material in the form compressed by extrusion of a wet powder which or pressing in order to intimately mix the binder and/or system capable of forming the binder/particulate starting material/water and to increase the intrinsic density and reduce the intrinsic porosity of the material, and to obtain, as a result of the hardening of the binder or binders, a hardened, solid mass which is in the form of the granulate of the size and/or shape desired, or is transformed into the granulate of the size and/or shape desired by cutting or crushing, immediately after compression or in a subsequent stage.

The starting particulate mineral material may be selected from sands, such as silica sand and basalt sand; non-reactive clays; sediments, such as dredged sediments; glass; coal; crushed concrete; crushed natural aggregates; quarry fines; industrial process fines; insulating materials such as rock wool and glass wool; and mixtures thereof.

The particulate mineral starting material or the mixture of particulate mineral starting materials can advantageously have a particle size defined by:
a D90 value less than or equal to 1.3 mm;
a D10 value greater than or equal to 0.02 mm; and
a D50 value greater than or equal to 0.1 mm and less than or equal to 1 mm,
   the said material or mixture of materials having been ground, if necessary, to obtain this particle size.

D90, D10, D50 means that 90%, 10%, 50% respectively of the particles by mass must have their smallest projected surface in each case of the size indicated.

For the aggregate to have the best properties, the mixture between the starting particulate mineral material and the binder or binder-forming system must be optimal within the composite forming this aggregate, i.e. the material-binder/binder-forming system contact surface must be as large as possible. However, if this surface area is too large, the material absorbs too much water and/or binder and the composite is therefore weakened. The particular values of D90, D10 and D50 given above are advantageous for such optimisation.

The Hardenable Mineral Binder(s) May be Selected from:
(a) hydraulically setting cementitious binders, such as NF EN 206 standard cements like Portland CEM I and Portland CEM III;
(b) mixtures based on at least three components selected from clinkers, metakaolins, gypsum, slag, limestone fillers, silica fume, ash, pozzolans and pozzolanic materials;
(c) mixtures of at least one binder defined in (a) and at least one component of a mixture as defined in (b)

The system or systems capable of forming a hardened mineral binder in an aqueous medium may consist of:
at least one precursor for forming a geopolymer or an activated alkali, chosen in particular from kaolins, metakaolins, shales, clays, slags, ashes and mixtures thereof, it being possible for the kaolins, shales and clays to have undergone a heat treatment such as calcination or flash treatment; and
at least one activator for forming an activated binder chosen from soda, potash and sodium and/or potassium silicates.

At least one shaping aid selected in particular from:
petroleum-based polymers, such as polyamides, polyacrylamides and concrete plasticizers and superplasticizers;
bio-based polymers, such as cornstarch or cellulose ether; and
mineral plasticisers, such as bentonite and non-reactive ash.

In a particularly preferred way, the mixture is obtained in the form of a wet powder from:
(A) 50 to 95 parts by weight, in particular 65 to 90 parts by weight, of said particulate starting material or materials; and
(B) 5 to 50 parts by weight, in particular 10 to 35 parts by weight, of said binder(s) and/or binder-forming system(s),
the water is added in a proportion of 2 to 40 parts by weight and the shaping aid(s) may be added up to 5 parts by weight,
all these parts by weight being given per 100 parts by weight of (A)+(B).

Water helps to harden the binder by participating in the hydraulic setting in the case of a hardenable mineral binder, or by constituting the medium in which the geopolymer or activated alkali is formed. Water can also help with compression by liquefying the mass to be compressed.

It is advantageous to adjust the quantities of the mixture before compression to obtain a wet powder rheology corresponding to a class S1 to S3 concrete according to standard NF EN 12 350-2, in particular class S1 (slump between 10 and 40 mm at the Abrams cone).

Mixing can be carried out in a paddle, ploughshare, ribbon or planetary mixer for between 3 seconds and 3 minutes.

The wet powder is advantageously compressed by extrusion, in a single-screw extruder or in a twin-screw extruder or by pressing with the aid of a piston press or a vibro-compaction press in order to obtain the desired aggregate directly or in order to obtain a strand which is then cut into the desired aggregate or with the aid of a compression wheel which makes it possible to obtain the desired aggregate directly.

### Compression Allows Several Phenomena:

increase in the intrinsic density of the material;
intimate mixture of binder, material and water;
reduction in the intrinsic porosity of the material; and
creating a minimum cohesion before the end of the maturation phase.

This means that without compression, the composite cannot remain in aggregate form while the maturation process takes place and at best will be filled with pores with non-activated binder and at worst will disintegrate before it has fully set.

Either after compression, or after shaping, or after compression and after shaping, the hardened product or the aggregate can advantageously be matured as appropriate in a closed chamber for a period of 1 hour to 10 days at a temperature of 15 to 70° C.

The present invention also relates to an aggregate as obtained by the process as defined above, having at least one characteristic from among:
water absorption in accordance with standard NF EN 1097-6 of less than 37% by weight;
a density in accordance with standard NF EN 1097-6 of 1.4 to 3 g/cm³, preferably 1.6 to 2.5 g/cm³; and
a Los Angeles coefficient according to standard EN 1097-2 of less than 85, preferably 10 to 70.

The aggregate as defined above advantageously has a particle size of 4 to 70 mm, preferably 4 to 31.5 mm.

Another object of the present invention is the use of the aggregate produced by the process as defined above or of the aggregate as defined above, as aggregate for concrete (ready-mixed concrete, prefabricated concrete, etc.), as aggregate for asphalt mix, as backfill for geotechnical use, as road sub-base or as decorative aggregate, the said granular material being used alone or mixed with other aggregates, for example with conventional aggregates such as aggregates, artificial natural aggregates or even recycled aggregates based in particular on crushed concrete.

The following Examples illustrate the present invention without limiting its scope.

In these examples, percentages and parts are given by weight unless otherwise stated.

### EXAMPLE 1

### Manufacture of an Aggregate from a Mixture of Sands

A sand mixture consisting of 70% silica sand and 30% basalt sand was ground to a particle size defined by a D90 of 1.3 mm, a D10 of 0.04 mm and a D50 of 0.3 mm.

A mixture in the form of a wet powder was then prepared, with the following composition:

TABLE 1

| | | |
|---|---|---|
| The resulting mixture of crushed sands | 74.8 | parts |
| Ternary mix of 4.25% gypsum, 80.75% clinker | 25.2 | parts |
| and 15% metakaolin (binder-forming system) | | |
| Water | 9.2 | parts |
| Visco crete sika Dynamon NG(MBS) | 0.88 | part |
| superplasticizer (shaping aid) | | |

The mixture thus prepared was then subjected to compression by passing it through a single-screw extruder, at the outlet of which the bonded mixture thus formed was cut into the form of a strand of aggregate with a particle size of [10; 14] mm.

The aggregate was then matured in a closed chamber for 7 days at 20° C.

### This Aggregate Presented:

a density of 2.16 g/cm³;
8% water absorption; and
a Los Angeles coefficient of 30.

### EXAMPLE 2

### Manufacture of an Aggregate from Recycled Glass

Recycled glass was ground to a particle size defined by a D90 of 0.6 mm, a D10 of 0.06 mm and a D50 of 0.2 mm.

A mixture in the form of a wet powder was then prepared, with the following composition:

TABLE 2

| | |
|---|---|
| Crushed glass obtained in this way | 76.1 parts |
| CEM III cement (binder) | 23.9 parts |
| Water | 11.1 parts |

The mixture was then compressed in a piston extruder to obtain blocks of the bonded mixture thus formed, which were matured in a closed chamber for 3 days at 25° C.

At the end of the maturing process, the blocks obtained were crushed to obtain an aggregate with a grain size of [6; 30 mm].

### This Aggregate Presented:

a density of 1.75 g/cm³;
a water absorption of 12%; and
a Los Angeles coefficient of 45.

### EXAMPLE 3

### Manufacture of an Aggregate Based on Limestone Quarry Fines

Limestone quarry fines were ground to a particle size defined by a D90 of 0.6 mm, a D10 of 0.02 mm and a D50 of 0.2 mm.

A mixture in the form of a wet powder was then prepared, with the following composition:

TABLE 3

| | | |
|---|---|---|
| Fine | 60 | parts |
| Activated slag (80% slag and | 40 | parts |
| 20% alkali silicate (marketed | | |
| by Wöllner) as an activator) | | |
| Water | 19 | parts |
| Non-reactive ash (shaping aid) | 1 | part |

The mixture prepared in this way was then compressed by passing it through a single-screw extruder, at the outlet of which the bonded mixture thus formed was cut into a strand of aggregate with a grain size of 10-20 mm.

The aggregate was then matured in a closed chamber for 1 day at 40° C.

### This Aggregate Presented:

a density of 2.2 g/cm³;
8% water absorption; and
a Los Angeles coefficient of 60.

What is claimed is:

1-12. (canceled)

13. Process for manufacturing a reconstituted mineral aggregate, wherein at least one particulate mineral starting material for aggregate is mixed with water and at least one mineral binder which can be hardened in the presence of water and/or at least one system capable of forming a hardened mineral binder in an aqueous medium, in order to obtain a material in the form of a wet powder which is compressed by extrusion or pressing in order to intimately mix the binder and/or system capable of forming the binder/particulate starting material/water and to increase the intrinsic density and reduce the intrinsic porosity of the material, and to obtain, as a result of the hardening of the binder or binders, a hardened, solid mass which is in the form of the granulate of the size and/or shape desired, or is transformed into the granulate of the size and/or shape desired by cutting or crushing, immediately after compression or in a subsequent stage.

14. Process according to claim 13, wherein the starting particulate mineral material is chosen from sands; non-reactive clays; sediments; glass; coal; crushed concrete; crushed aggregates; quarry fines; industrial process fines; insulating materials; and mixtures thereof.

15. Process according to claim 14, wherein the sands are chosen from silica sand and basalt sand, the sediments are chosen from dredging sediments, and the insulating materials are chosen from rock wool and glass wool.

16. Process according to claim 13, wherein the particulate mineral starting material or the mixture of particulate mineral starting materials has a particle size defined by:
a D90 value less than or equal to 1.3 mm;
a D10 value greater than or equal to 0.02 mm; and
a D50 value greater than or equal to 0.1 mm and less than or equal to 1 mm, the material or mixture of materials having been ground, if necessary, to obtain this particle size.

17. Process according to claim 13, wherein the hardenable mineral binder or binders are chosen from:
a) hydraulically setting cementitious binders;
b) mixtures based on at least three components selected from clinkers, metakaolins, gypsum, slag, limestone fillers, silica fume, ash, pozzolans and pozzolanic materials;
c) mixtures of at least one binder defined in (a) and at least one component of a mixture as defined in (b).

18. Process according to claim 17, wherein the hydraulically setting cementitious binders are chosen from Portland CEM I and Portland CEM III.

19. Process according to claim 13, wherein the system or systems capable of forming a hardened mineral binder in an aqueous medium consist of:
at least one precursor for forming a geopolymer or an activated alkali; and
at least one activator for forming an activated binder chosen from soda, potash and sodium and/or potassium silicates.

20. Process according to claim 19, wherein the at least one precursor for forming a geopolymer or an activated alkali is chosen from kaolins, metakaolins, shales, clays, slags, ashes and mixtures thereof, it being possible for the kaolins, shales and clays to have undergone a heat treatment.

21. Process according to claim 13, wherein at least one shaping aid chosen from:
petroleum-based polymers;
bio-based polymers; and
mineral plasticisers,
is incorporated into the mixture leading to the wet powder.

22. Process according to claim 21, wherein the petroleum-based polymers are chosen from polyamides, polyacrylamides and concrete plasticizers and superplasticizers, wherein the bio-based polymers are chosen from cornstarch and cellulose ether and wherein the mineral plasticisers are chosen from bentonite and non-reactive ash.

23. Process according to claim 13, wherein the mixture is obtained in the form of a wet powder from:
(A) 50 to 95 parts by weight of particulate starting material or materials; and
(B) 5 to 50 parts by weight of binder(s) and/or binder-forming system(s),
the water is added in a proportion of 2 to 40 parts by weight and the shaping aid(s) may be added up to 5 parts by weight,
all these parts by weight being given per 100 parts by weight of (A)+(B).

24. Process according to claim 23, wherein the particulate starting material or materials are present at 65 to 90 parts by weight and binder(s) and/or binder-forming system(s) are present 10 to 35 parts by weight.

25. Process according to claim 13, wherein the compression of the wet powder is carried out by extrusion in a single-screw extruder or in a twin-screw extruder or by pressing with the aid of a piston press or a vibro-compaction press in order to obtain the desired aggregate directly or in order to obtain a strand which is then cut into the desired aggregate or with the aid of a compression wheel which makes it possible to obtain the desired aggregate directly.

26. Process according to claim 13, wherein, either after compression, or after shaping, or after compression and after shaping, the hardened product or the aggregate is matured, as appropriate, in a closed chamber for a period of 1 hour to 10 days at a temperature of 15 to 70° C.

27. Aggregate obtained by the process as defined in claim 13, having at least one of:
water absorption in accordance with standard NF EN 1097-6 of less than 30% by weight;
a density according to standard NF EN 1097-6 of 1.5 to 3 g/cm³; and
a Los Angeles coefficient according to standard EN 1097-2 of less than 80.

28. Aggregate according to claim 27, wherein the density is of 1.6 to 2.5 g/cm³ and wherein the Los Angeles coefficient is between 10 and 70.

29. Aggregate according to claim 27, wherein the aggregate has a particle size of 4 to 70 mm.

30. Aggregate according to claim 29, wherein the aggregate has a particle size of 4 to 31.5 mm.

31. Aggregate manufactured by the process according to claim 13, for use as aggregate for concrete, as aggregate for asphalt, as backfill for geotechnical use, as road sub-base or as decorative aggregate, said aggregate being used alone or mixed with other aggregates.
